(19) United States
(12) Patent Application Publication
(10) Pub. No.: US 2019/0087511 A1
(43) Pub. Date: Mar. 21, 2019

(54) DESIGN-INFORMATION PROCESSING APPARATUS AND NON-TRANSITORY COMPUTER READABLE MEDIUM

(71) Applicant: FUJI XEROX CO., LTD., Tokyo (JP)

(72) Inventor: Aoi TANIGUCHI, Kanagawa (JP)

(73) Assignee: FUJI XEROX CO., LTD., Tokyo (JP)

(21) Appl. No.: 16/126,391

(22) Filed: Sep. 10, 2018

(30) Foreign Application Priority Data
Sep. 21, 2017 (JP) 2017-180806

(51) Int. Cl. G06F 17/50

(52) U.S. Cl. CPC G06F 17/50; G06F 2217/04; G06F 2217/06; G06F 2217/02

(57) ABSTRACT

A design-information processing apparatus includes a design-change-information acquiring unit, a simulation-information acquiring unit, a difference-information obtaining unit, and a presenting unit. The design-change-information acquiring unit acquires design-change information indicating a change parameter changed in design in multiple design parameters and a changed content of the change parameter. The simulation-information acquiring unit acquires simulation information corresponding to the change in design. The difference-information obtaining unit obtains difference information between simulation results before and after the change in design based on the simulation information. The presenting unit presents characteristic difference information included in the difference information in association with the change parameter and the changed content corresponding to the characteristic difference information.

### CROSS-REFERENCE TO RELATED APPLICATIONS

This application is based on and claims priority under 35 USC 119 from Japanese Patent Application No. 2017-180806 filed Sep. 21, 2017.

### BACKGROUND

### Technical Field

The present invention relates to design-information processing apparatuses and non-transitory computer readable media.

### SUMMARY

According to an aspect of the invention, there is provided a design-information processing apparatus including a design-change-information acquiring unit, a simulation-information acquiring unit, a difference-information obtaining unit, and a presenting unit. The design-change-information acquiring unit acquires design-change information indicating a change parameter changed in design in multiple design parameters and a changed content of the change parameter. The simulation-information acquiring unit acquires simulation information corresponding to the change in design. The difference-information obtaining unit obtains difference information between simulation results before and after the change in design based on the simulation information. The presenting unit presents characteristic difference information included in the difference information in association with the change parameter and the changed content corresponding to the characteristic difference information.

### BRIEF DESCRIPTION OF THE DRAWINGS

An exemplary embodiment of the present invention will be described in detail based on the following figures, wherein:

FIG. 1 illustrates a specific example of a design-information processing apparatus according to an exemplary embodiment of the present invention;

FIG. 2 illustrates a specific example of a process executed by the design-information processing apparatus;

FIG. 3 illustrates a specific example of a model to be designed;

FIGS. 4A and 4B illustrate specific examples of basic shape data and CAD parameters other than the basic shape data;

FIG. 5 illustrates a specific example of multiple lattice points generated for calculation;

FIGS. 6A to 6C illustrate specific examples of simulation history;

FIG. 7 illustrates a specific example of a filter condition;

FIG. 8 illustrates a specific example of how physical values are extracted; and

FIG. 9 illustrates a specific example of a display image.

### DETAILED DESCRIPTION

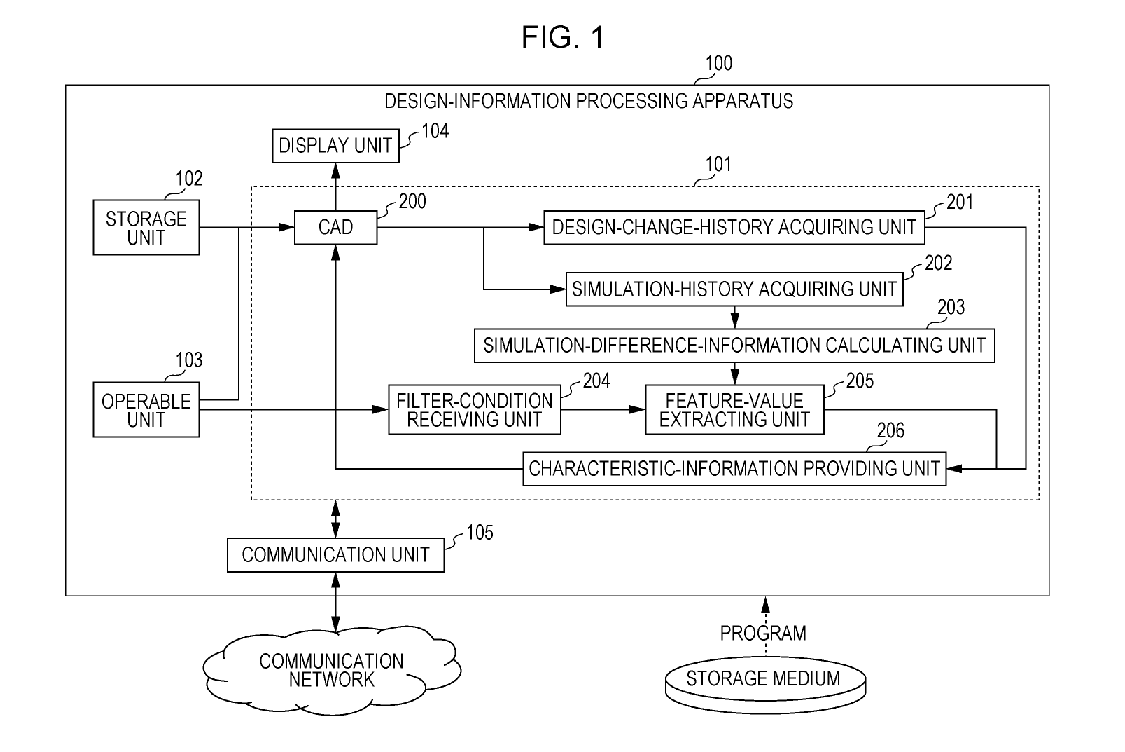

FIG. 1 illustrates a specific example of a design-information processing apparatus according to an exemplary embodiment of the present invention. A design-information processing apparatus 100 shown in FIG. 1 includes a controller 101, a storage unit 102, an operable unit 103, a display unit 104, and a communication unit 105.

The controller 101 is realized by, for example, hardware, such as a central processing unit (CPU), and software, such as a program, operating in cooperation with each other. The controller 101 includes a computer-aided design (CAD) unit 200, a design-change-history acquiring unit 201, a simulation-history acquiring unit 202, a simulation-difference-information calculating unit 203, a filter-condition receiving unit 204, a feature-value extracting unit 205, and a characteristic-information providing unit 206. A specific example of a process executed by the controller 101 will be described in detail later.

The storage unit 102 is a storage device, such as a hard disk drive, and stores a program to be executed by the controller 101. Moreover, the storage unit 102 functions as a working memory for the controller 101.

The operable unit 103 is a user interface realized by an operable device, such as a keyboard or a mouse. The operable unit 103 receives an operation from a user (such as a system manager) using the design-information processing apparatus 100 and outputs a command according to the operation to the controller 101.

The display unit 104 is a display device, such as a liquid crystal display or a cathode-ray-tube (CRT) display, and displays information obtained from the controller 101.

The communication unit 105 is, for example, a network interface connected to a communication network and exchanges information via the communication network in accordance with a command from the controller 101.

The design-information processing apparatus 100 in FIG. 1 may be realized by using, for example, a computer. The computer includes hardware resources including an arithmetic device, such as a CPU, a storage device, such as a memory device or a hard disk, a communication device that uses a communication line, such as the Internet, a device that reads and writes data from and to a storage medium, such as an optical disk or a semiconductor memory, a display device, such as a display, and an operable device that receives an operation from a user.

For example, a program (software) corresponding to at least one or more functions of multiple functions that are given reference signs in the design-information processing apparatus 100 in FIG. 1 is loaded into the computer. The hardware resources included in the computer and the loaded software operate in cooperation with each other so that the at least one or more functions included in the design-information processing apparatus 100 are realized. The program may be provided to the computer (i.e., the design-information processing apparatus 100) via a communication network, such as the Internet, or may be provided to the computer (i.e., the design-information processing apparatus 100) by being stored in a storage medium, such as an optical disk.

The overall configuration of the design-information processing apparatus 100 in FIG. 1 has been described above. Next, a process executed by the design-information processing apparatus 100 in FIG. 1 will be described in detail. With regard to the components shown in FIG. 1, the reference signs in FIG. 1 will be used in the following description.

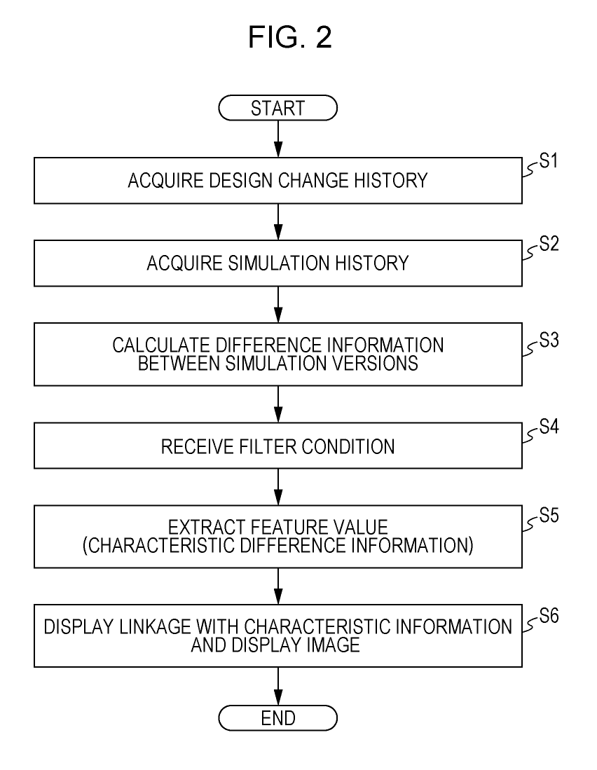

FIG. 2 is a flowchart illustrating a specific example of the process executed by the design-information processing apparatus 100. The specific example of the process executed by the design-information processing apparatus 100 will be described with reference to the flowchart in FIG. 2.

In step S1 in FIG. 2, the design-change-history acquiring unit 201 acquires a design change history from a program interface of the CAD unit 200. The CAD unit 200 is a design support tool and handles CAD data (i.e., design information) of each model to be designed.

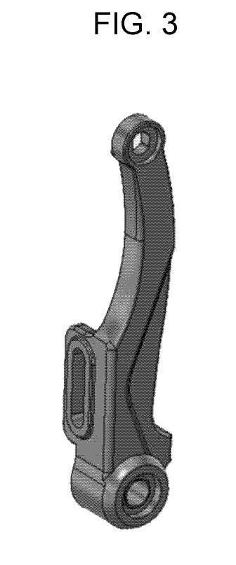

FIG. 3 illustrates a specific example of a model to be designed. The CAD unit 200 has a function of performing various simulations related to models to be designed. For example, a result of a simulation performed in the past with respect to each model is stored in correspondence with the CAD data of the model as a simulation history. If there is a change in design with respect to the model, a design change history, which is history information related to the design change contents of the model, is stored in correspondence with the CAD data of the model.

The design-change-history acquiring unit 201 acquires the design change history from the program interface of the CAD unit 200. The design change history includes, for example, the following contents:

registration, deletion, and dimensional change of basic shape data constituting each model;

change of material;

change of joint condition;

importing of existing CAD data; and

usage condition (change of initial condition used in each simulation and boundary condition (e.g., load condition and constraint condition)).

The design change history may also include, for example, a change of basic shape data to be described below (registration, deletion, and dimensional change) and a change of CAD parameters other than the basic shape data.

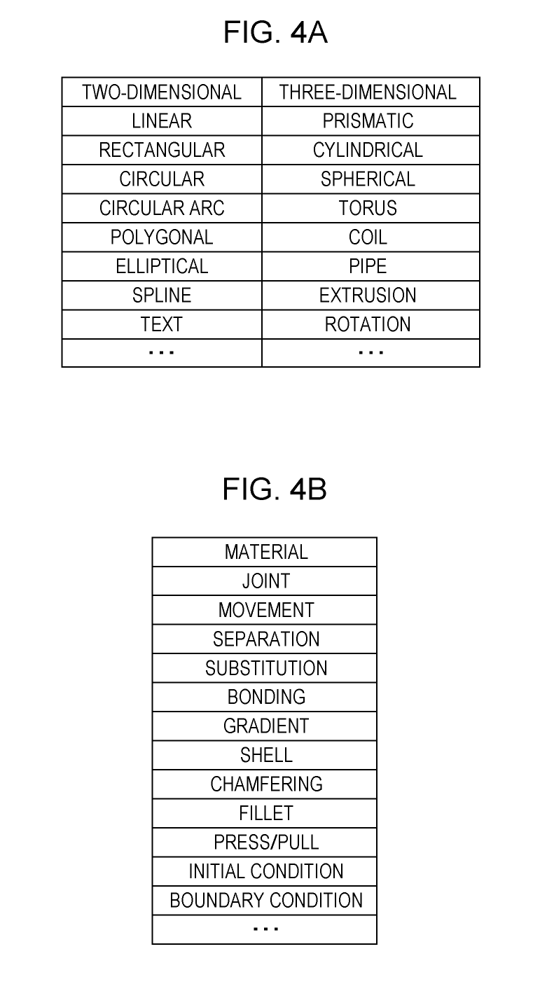

FIGS. 4A and 4B illustrate specific examples of the basic shape data and CAD parameters other than the basic shape data. FIG. 4A illustrates two-dimensional basic shape data and three-dimensional basic shape data as specific examples of the basic shape data. The two-dimensional basic shape data includes, for example, “linear”, “rectangular”, “circular”, and “circular arc” shapes, and the three-dimensional basic shape data includes, for example, “prismatic”, “cylindrical”, “spherical”, and “torus” shapes.

FIG. 4B illustrates a specific example of CAD parameters other than the basic shape data. The CAD parameters other than the basic shape data include, for example, “material”, “joint”, “movement”, and “separation” parameters. Alternatively, basic shape data and CAD parameters other than the specific examples shown in FIGS. 4A and 4B may be used.

Furthermore, in step S1 in FIG. 2, the design-change-history acquiring unit 201 acquires simulation setting information as a part of the design change history from the CAD unit 200. The CAD unit 200 includes a setting unit that performs various types of setting processes in a simulation, and also includes an acquiring unit that acquires various types of setting information set in the simulation.

In addition to a structural analysis (force−deformation), the simulation in the CAD unit 200 may involve various types of calculations, such as a vibration analysis (analysis of vibration−force/deformation), a thermal analysis, a thermal stress analysis (heat−force), and a buckling analysis (i.e., a type of structural analysis). The simulation setting information varies depending on the type of simulation.

For example, a constraint condition is one of specific examples of setting information in a simulation of a structural analysis, and the setting information in the simulation of the structural analysis includes, for example, the following specific examples:

load (magnitude of load, load position and load direction);

constraint condition (constraint position and constraint method (fixing method, pin-based fixing method, no-friction method, or forced displacement method));

material; and

contact analysis setting (detection of interference between models).

In step S2 in FIG. 2, the simulation-history acquiring unit 202 acquires a simulation history of an old version (e.g., first version) and a simulation history of a new version (e.g., latest version) from the program interface of the CAD unit 200. In the simulation, for example, multiple lattice points for calculation are normally used.

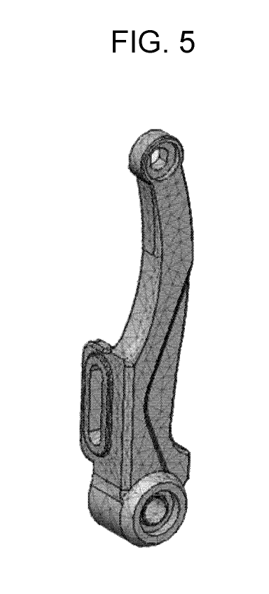

FIG. 5 illustrates a specific example of multiple lattice points generated for calculation. The multiple lattice points in the specific example shown in FIG. 5 are generated in the form of mesh by using the model in FIG. 3. In the simulation, as in the specific example shown in FIG. 5, for example, a general procedure involves forming multiple lattice points for calculation in an analytical target (i.e., analytical space) and applying a dominant equation at each lattice point.

The simulation history includes, for example, various types of physical values determined in accordance with the type of simulation. For example, the simulation history of structural calculation includes the following physical values:

displacement (for the number of lattice points used in simulation);

tensile distortion (for the number of lattice points used in simulation);

shearing strain (for the number of lattice points used in simulation);

internal stress (for the number of lattice points used in simulation); and

eigenvalue.

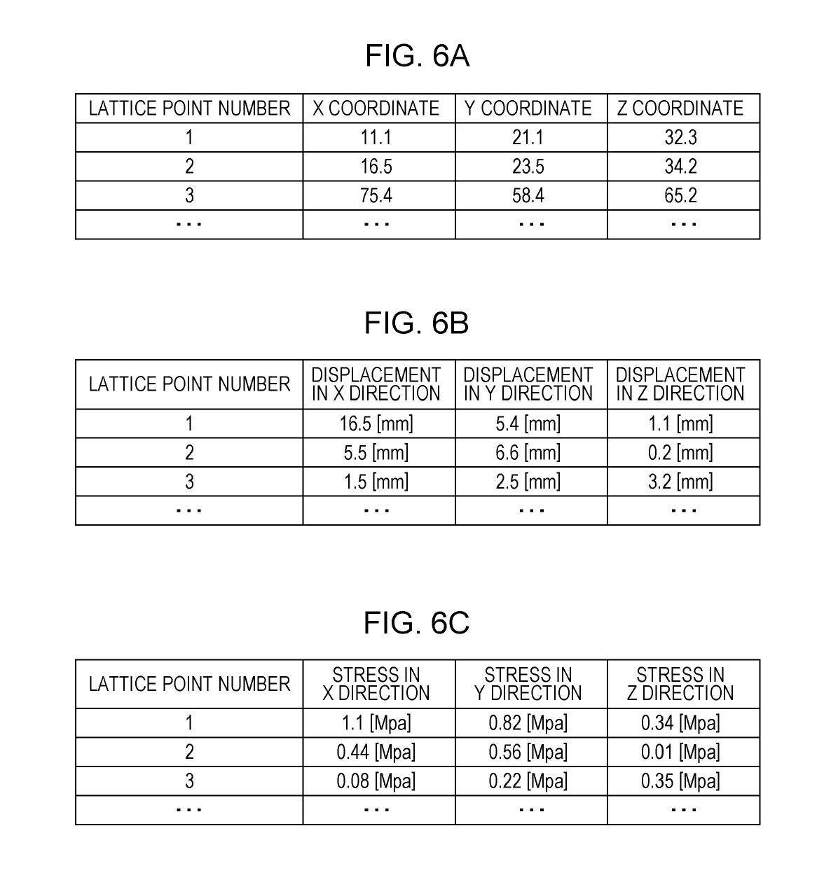

FIGS. 6A to 6C illustrate specific examples of simulation history. In addition to the coordinates of each calculation lattice point, information about various types of physical values determined in accordance with the type of simulation is stored in association with each lattice point in the simulation history.

FIGS. 6A to 6C illustrate the lattice coordinates of each lattice point (each lattice point number) (i.e., XYZ coordinates of each lattice point), displacement at each lattice point (i.e., displacement components in the XYZ directions), and stress at each lattice point (i.e., stress components in the XYZ directions), as specific examples of information included in the simulation history.

In step S3 in FIG. 2, the simulation-difference-information calculating unit 203 calculates a difference in each type of physical value included in the simulation history of the old version (e.g., first version) and the simulation history of the new version (e.g., latest version) acquired by the simulation-history acquiring unit 202. For example, the difference is calculated for each lattice point.

For example, lattice points corresponding to each other between the old version and the new version are determined in accordance with processes described below.

A first process involves storing a relative position from a reference point of a model of interest to a target lattice point in the old version. For example, the coordinates of a relative position in a coordinate system having the reference point of the model as a point of origin is stored.

A second process involves disposing a new version of the model of interest in the old version in the same coordinate system as in the first process and employing a lattice point closest to the coordinates of the relative position stored in the first process as a lattice point corresponding to the target lattice point in the old version. However, if the distance between the lattice point in the new version and the lattice point in the old version that is closest to the lattice point in the new version is larger than a determination value (i.e., a fixed value or a percentage relative to the representative length of the model of interest), it may be determined that there is no corresponding lattice point, and the difference information does not have to be calculated.

In step S4 in FIG. 2, the filter-condition receiving unit 204 receives a filter condition for determining characteristic information in the simulation-difference information calculated by the simulation-difference-information calculating unit 203. For example, a user operates the operable unit 103 to input the filter condition. For example, the filter condition includes the following contents:

a physical value to be monitored; and

a variation rate of the physical value to be monitored (model/basic shape/physical value).

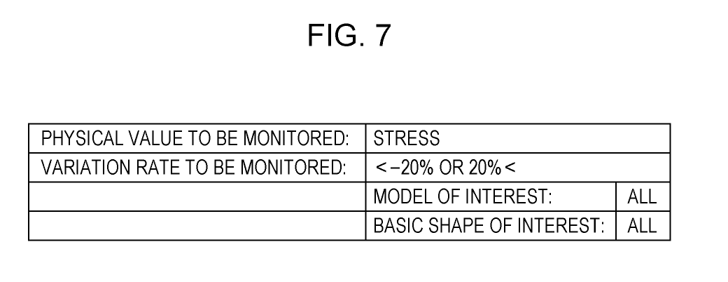

FIG. 7 illustrates a specific example of the filter condition. A physical value to be monitored is a physical value to be extracted as a feature value (i.e., characteristic difference information), and a variation rate to be monitored is a variation rate to be extracted as a feature value. For example, in the specific example shown in FIG. 7, “stress” is set as a physical value to be monitored, and “lower than −20% or higher than 20%” is set as a variation rate to be monitored. Furthermore, for example, a model or basic shape to be extracted may be set as a filter condition, as in the specific example shown in FIG. 7.

In step S5 in FIG. 2, the feature-value extracting unit 205 extracts, as a feature value (i.e., characteristic difference information), difference information that matches the filter condition obtained from the filter-condition receiving unit 204 from the difference information obtained from the simulation-difference-information calculating unit 203.

For example, by using the filter condition shown in FIG. 7, difference information with a stress value lower than −20% or higher than 20% is extracted as a feature value (i.e., characteristic difference information) with respect to all models and all basic shapes from the simulation-difference information calculated by the simulation-difference-information calculating unit 203.

In a case where multiple pieces of difference information are included in the same basic shape data, for example, it is desirable that the difference information to be ultimately used be narrowed down in accordance with processes described below.

A first process involves storing difference information with the largest variation rate from among multiple pieces of difference information with the same physical-value variation direction.

A second process involves employing, as feature values (i.e., characteristic difference information), pieces of difference information stored one after another by executing the first process for each feature value and each variation direction.

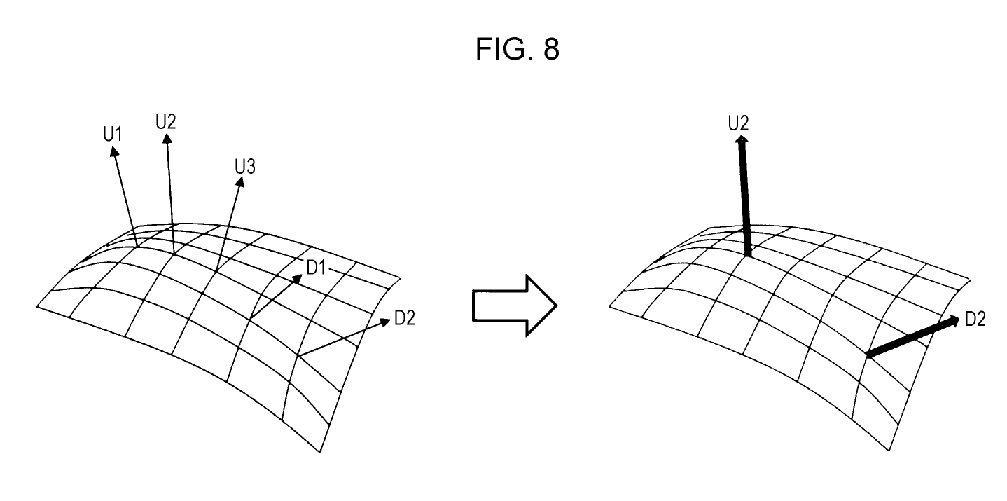

FIG. 8 illustrates a specific example of how feature values are extracted. The specific example shown in FIG. 8 relates to a case where multiple pieces of difference information matching the filter condition are included in the same basic shape data. In FIG. 8, difference information U1, difference information U2, and difference information U3 are difference information with upward variation directions, and difference information D1 and difference information D2 are difference information with downward variation directions.

First, in the first process, difference information with the largest variation rate is selected (stored) from among multiple pieces of difference information with the same physical-value variation direction. For example, in the specific example in FIG. 8, the difference information U2 has the largest variation rate among the difference information U1, the difference information U2, and the difference information U3 with the upward variation directions. Furthermore, in the specific example in FIG. 8, the difference information D2 has the largest variation rate between the difference information D1 and the difference information D2 with the downward variation directions.

Then, pieces of difference information stored one after another by executing the first process for each feature value and each variation direction are employed as feature values (i.e., characteristic difference information). For example, in the specific example in FIG. 8, the first process is executed for each variation direction, that is, each of the upward and downward directions, so that the difference information U2 in the upward direction and the difference information D2 in the downward direction are employed as feature values (i.e., characteristic difference information).

In step S6 in FIG. 2, the characteristic-information providing unit 206 presents the feature values (i.e., characteristic difference information) extracted by the feature-value extracting unit 205 in association with change parameters and the changed contents thereof corresponding to the feature values.

For example, the change parameters are included in the design change history acquired by the design-change-history acquiring unit 201 from the CAD unit 200. The change parameters may be parameters set when performing a simulation.

For example, the characteristic-information providing unit 206 forms a display image indicating that the characteristic difference information has been obtained as a result of a change of the change parameters corresponding to the characteristic difference information. The formed display image is displayed on the display unit 104 via the program interface of the CAD unit 200.

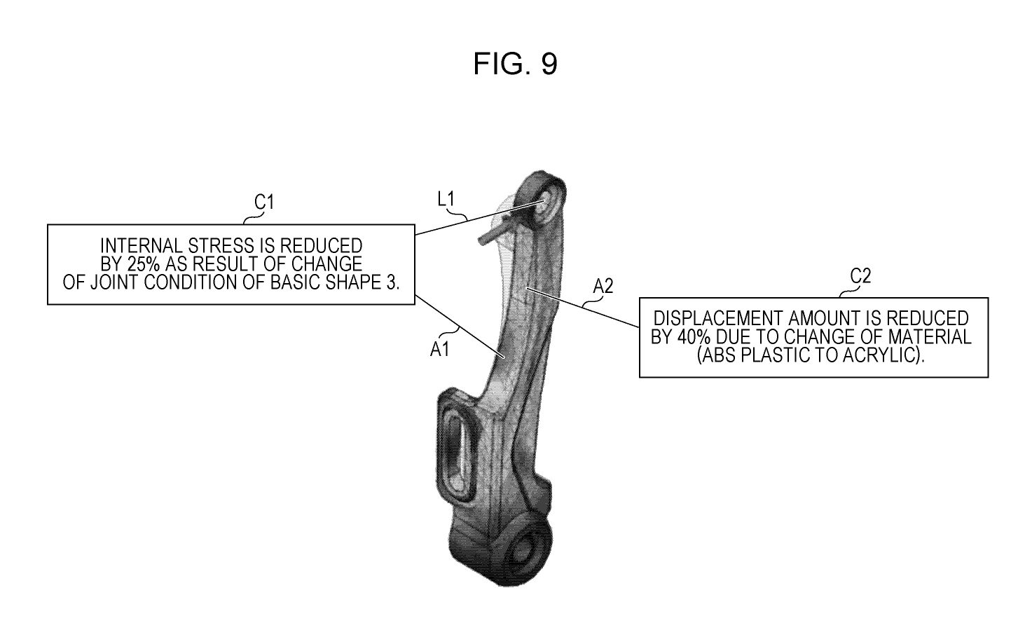

FIG. 9 illustrates a specific example of the display image. The specific example of the display image shown in FIG. 9 is formed by the characteristic-information providing unit 206 and is displayed on the display unit 104.

For example, the characteristic-information providing unit 206 changes the change parameters corresponding to the characteristic difference information so as to form the display image indicating that the characteristic difference information has been obtained. For example, in a case where difference information indicating that the internal stress is reduced by 25% is extracted as the characteristic difference information and the difference information is realized in accordance with a change of joint condition related to a basic shape 3, a display image including a comment C1 indicating that “the internal stress is reduced by 25% as a result of a change of joint condition of the basic shape 3” is formed, as in the specific example shown in FIG. 9. Moreover, in a case where difference information indicating that the displacement amount is reduced by 40% is extracted as the characteristic difference information and the difference information is realized as a result of a change from an acrylonitrile-butadiene-styrene (ABS) plastic material to an acrylic material, for example, a display image including a comment C2 indicating that “the displacement amount is reduced by 40% due to a change of material (ABS plastic to acrylic)” is formed, as in the specific example shown in FIG. 9.

It is desirable that the characteristic-information providing unit 206 indicate a model to be changed in design in the display image. For example, a display image including a model to be changed in design (see FIG. 3) is formed, as in the specific example shown in FIG. 9. As the model to be changed in design, it is desirable that a design-changed model before and after a simulation be displayed. For example, the design-changed model before the simulation and the design-changed model after the simulation may be displayed in an overlapping manner, as in the specific example shown in FIG. 9.

Furthermore, the characteristic-information providing unit 206 may form a display image indicating a model to be changed in design and a part where characteristic difference information in the model is obtained. For example, as in the specific example shown in FIG. 9, an arrow A1 extending from the comment C1 indicating the characteristic difference information (i.e., the internal stress is reduced by 25%) may indicate a part in the model where the characteristic difference information (i.e., the internal stress is reduced by 25%) is obtained. Moreover, as in the specific example shown in FIG. 9, an arrow A2 extending from the comment C2 indicating the characteristic difference information (i.e., the displacement amount is reduced by 40%) may indicate a part in the model where the characteristic difference information (i.e., the displacement amount is reduced by 40%) is obtained. Accordingly, a display image in which characteristic difference information and a part where the characteristic difference information is obtained are associated with each other is realized.

Furthermore, the characteristic-information providing unit 206 may form a display image in which a change parameter and the changed contents thereof are associated with a part where characteristic difference information is obtained. For example, in the specific example shown in FIG. 9, since the comment C1 includes a change parameter (i.e., a change of joint condition related to the basic shape 3), the change parameter (i.e., the change of joint condition related to the basic shape 3) and the part in the model where the characteristic difference information (i.e., the internal stress is reduced by 25%) is obtained are associated with each other by the arrow A1. Furthermore, for example, in the specific example shown in FIG. 9, since the comment C2 includes a change parameter (i.e., the change of material), the change parameter (i.e., the change of material) and the part in the model where the characteristic difference information (i.e., the displacement amount is reduced by 40%) is obtained are associated with each other by the arrow A2.

Furthermore, the characteristic-information providing unit 206 may form a display image in which a part corresponding to a change parameter and the changed contents thereof are associated with characteristic difference information. For example, in the specific example shown in FIG. 9, the part corresponding to the change parameter (i.e., the part where the joint condition of the basic shape 3 is changed) and the comment C1 indicating the characteristic difference information (i.e., the internal stress is reduced by 25%) are associated with each other by a line L1.

The part corresponding to the change parameter is not necessarily limited to a part in the model. For example, if the model has no part corresponding to the change parameter in the comment C2 in the specific example shown in FIG. 9, a line indicating the part corresponding to the change parameter is omitted, as in the specific example shown in FIG. 9, such that only the single arrow A2 indicating the part where the characteristic difference information (i.e., the displacement amount is reduced by 40%) is obtained is formed.

Furthermore, the change parameter corresponding to the characteristic difference information may be a change parameter (such as the load, constraint condition, or material) set when performing a simulation. The characteristic-information providing unit 206 may form a display image indicating a model to be changed in design, a change parameter set when performing a simulation, and a part where characteristic difference information in the model is obtained.

Characteristic difference information also has an aspect of an effect caused by a change of change parameter. For example, in the specific example shown in FIG. 9, the characteristic difference information in the comment C1 (i.e., the internal stress is reduced by 25%) is also an effect caused by a change of change parameter (i.e., a change of joint condition related to the basic shape 3), and the characteristic difference information in the comment C2 (i.e., the displacement amount is reduced by 40%) is also an effect caused by a change of change parameter (i.e., a change of material).

For example, when there is a change in design for a certain purpose but the relationship between the purpose for the change in design and a changed parameter is not clearly stated, the purpose for the change in design may sometimes be not clear for those other than the person who has changed the design. In contrast, for example, if an effect caused by a change of change parameter is displayed as characteristic difference information, as in the specific example shown in FIG. 9, it is clear to users other than the person who has changed the design that the change in design is intended for the effect displayed as characteristic difference information.

The exemplary embodiment of the present invention has been described above. According to the above exemplary embodiment, for example, since it is possible to refer to the design know-how of the basic shape not clearly stated previously, it is relatively easy to determine the necessity of the specific basic shape in design, which may be difficult to determine simply based on the already-existing clearly-stated know-how. Moreover, a fault in product design caused by using a wrong basic shape may be reduced. Furthermore, according to the above exemplary embodiment, the subject to which the know-how is to be accumulated is increased to multiple CAD parameters including the basic shape, whereby the know-how related to the multiple CAD parameters is accumulated.

The above exemplary embodiment is merely an example in all aspects, and is not intended to limit the scope of the invention. The exemplary embodiment of the present invention includes various modifications within a scope that does not depart from the spirit of the invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A design-information processing apparatus comprising:
a design-change-information acquiring unit that acquires design-change information indicating a change parameter changed in design in a plurality of design parameters and a changed content of the change parameter;
a simulation-information acquiring unit that acquires simulation information corresponding to the change in design;
a difference-information obtaining unit that obtains difference information between simulation results before and after the change in design based on the simulation information; and
a presenting unit that presents characteristic difference information included in the difference information in association with the change parameter and the changed content corresponding to the characteristic difference information.

2. The design-information processing apparatus according to claim 1,
wherein a display image indicating that the characteristic difference information is obtained as a result of a change of the change parameter corresponding to the characteristic difference information is formed.

3. The design-information processing apparatus according to claim 1,
wherein a display image that indicates a model to be changed in design and a part where the characteristic difference information in the model is obtained is formed.

4. The design-information processing apparatus according to claim 3,
wherein the formed display image indicates the model to be changed in design, the change parameter set when performing a simulation, and the part where the characteristic difference information in the model is obtained.

5. The design-information processing apparatus according to claim 4,
wherein, in the formed display image, the change parameter set when performing the simulation and the part where the characteristic difference information is obtained are associated with each other.

6. The design-information processing apparatus according to claim 4,
wherein, in the formed display image, the part corresponding to the change parameter set when performing the simulation and the characteristic difference information are associated with each other.

7. The design-information processing apparatus according to claim 3,
wherein, in the formed display image, the characteristic difference information and the part where the characteristic difference information is obtained are associated with each other.

8. The design-information processing apparatus according to claim 3,
wherein a design-changed model before and after a simulation is displayed as the model to be changed in design.

9. The design-information processing apparatus according to claim 1,
wherein the characteristic difference information includes an effect caused by a change of the change parameter.

10. The design-information processing apparatus according to claim 1, further comprising:
a receiving unit that receives an input of an extracting condition from a user; and
an extracting unit that extracts the characteristic difference information satisfying the extracting condition from the difference information.

11. The design-information processing apparatus according to claim 10,
wherein the extracting condition includes a physical value to be extracted as the characteristic difference information and a variation amount of the physical value.

12. A non-transitory computer readable medium storing a program causing a computer to execute a process, the process comprising:
acquiring design-change information indicating a change parameter changed in design in a plurality of design parameters;
acquiring simulation information corresponding to the change in design;
obtaining difference information between simulation results before and after the change in design based on the simulation information; and
presenting characteristic difference information included in the difference information and the change parameter corresponding to the characteristic difference information.

13. A design-information processing apparatus comprising:
design-change-information acquiring means for acquiring design-change information indicating a change parameter changed in design in a plurality of design parameters and a changed content of the change parameter;
simulation-information acquiring means for acquiring simulation information corresponding to the change in design;
difference-information obtaining means for obtaining difference information between simulation results before and after the change in design based on the simulation information; and
presenting means for presenting characteristic difference information included in the difference information in association with the change parameter and the changed content corresponding to the characteristic difference information.
